(19) United States
(12) Patent Application Publication
(10) Pub. No.: US 2004/0070260 A1
(43) Pub. Date: Apr. 15, 2004

(54) Wheel hub assemblies

(76) Inventors: Thiam Eng Chung, Leicestershire (GB); Paul Anthony Fannon, Coventry (GB)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/344,545

(22) PCT Filed: Aug. 7, 2001
(86) PCT No.: PCT/GB01/03565

(30) Foreign Application Priority Data
Aug. 11, 2000 (GB) 0019845.7
May 15, 2001 (GB) 0111846.2

(51) Int. Cl. B60B 1/02

(52) U.S. Cl. 301/59

(57) ABSTRACT

A wheel hub assembly, particularly for an aircraft, comprises two hub portions (1, 2) bolted together at intervals around their circumference by bolts (10) having a conical profile and scaled in countersunk portions (9) of the bolt holes. The included angle of the conical profile is preferably in the range 85° to 140°. This arrangement reduces the maximum principal stress in the hub during use and tends to alleivate fretting damage at the interface of the hub portions.

This invention relates to a high performance wheel hub assembly, particularly for aircraft. An aircraft wheel assembly typically comprises two halves, i.e. hubs, which are bolted together by bolts passing through bolt holes, flat washers being present under the head of the bolts and nuts. Such an assembly is often called an “A” frame type. These hubs are typically made of aluminium alloy.

It is known to use a conical washer between a bolt head and the wall of a wheel through which it passes. See e.g. GB 404143; GB 580395; GB 759048 and GB 827849. In these disclosures, dating from the 1930's to the 1950's, the wheel is made of steel and fretting damage does not occur. Such wheels would not be suitable for high performance applications. In other proposals, e.g. GB 626512 and GB 1031011 which relate to aircraft wheels, the wheels are made of aluminium alloy but washers are not present.

There have been changes in loading conditions of aircraft and these have had an impact on the wheel assemblies. The loads have increased as a result of increased aircraft operating weights. Design safety margins have been reduced to minimise the weight of the wheel. The use of radial ply tyres has increased and these undergo greater deflection than wheels having bias tyres because of the construction of the tyre. The greater deflection of a radial ply tyre gives the tyre an oval shape and this results in higher loads on the bolts of the wheel assembly. The combination of a high concentration of static tensile stresses due to bolt fastening, tyre inflation and fluctuating stresses generated by rolling of the wheel have imposed high stresses in the region of the hub around the bolt holes, i.e. at the spot face/tube well fillet.

There is necessarily a clearance between the bolt shank and the wheel hub. Dynamic stresses during rotation of the wheel under load cause small relative movements at the washer-to-hub interface and at the hub-to-hub interface, these small movements being possible because of the clearance around the bolts. The relative movements at the washer/hub and hub/hub interfaces result in fretting damage which can lead to cracks and low cycle fatigue failure. Thicker, larger diameter flat washers have been used to address the problem. This can reduce the problem at the washer/hub interface but does not reduce damage at the hub/hub interface.

It is one object of this invention to reduce stress at critical regions of the hub in order to ameliorate at least some of the above problems.

According to the invention in one aspect, there is provided a high performance wheel hub assembly comprising two axially adjacent hub portions of lightweight material bolted together by circumferentially distributed fastening assemblies comprising bolts extending through bolt holes in the hub portions, the bolt holes in at least one hub portion having tapered countersunk portions in which are seated complementary expanded portions of the fastening assemblies, the countersunk portions being located and dimensioned to reduce the maximum principal stress in the surrounding region of said hub portion during use.

Preferably said expanded portions comprise washers having a generally conical profile.

Our investigation has established that a conical seat spot face in the wheel half hub of between about 85° and about 140° included angle introduces compressive radial stresses to the fillet area at the edge of the spot face. The significant feature associated with the introduction of such compressive radial stresses is the shift in location of the larger principal stresses away from a band of material at the fillet radius nearest the tubewell of the hub to areas around the circular edge between the bolt hole and the conical seat. The levels of these stresses are typically 20% lower than the stresses at the fillet radius in the design with a flat washer spot face. Another feature of the conical spot face is the gradual distribution of compressive stresses outwards from the bolt hole. This reduction in stress gradient between the high compressive and yield stresses eliminates the possibility of low cycle fatigue failure at this location.

Accordingly the included angle of the countersunk portion is preferably in the range 85° to 150°, more preferably 100° to 140°. Optimum stress distribution is obtained when the angle of taper is about 140°.

For clamping efficiency, the included angle is preferably between 100° to 110°. In practice however, the position of the tyre pressure sealing groove may dictate a lesser included angle e.g. at little as about 85°.

The washers or other expanded portions are preferably made of stainless steel or a material having like properties. It is preferred that the washer be made of a material ductile enough to accommodate any mismatch between the taper angles. The corrosion resisting steel grade BS. 6S80 exhibiting hardness values of between 255 and 321 HB has been found to be more satisfactory than other “harder” grades of steel. The corrosion resistance of the BS.6S80 material can be enhanced by nitric acid passivation. Our tests have demonstrated that the washers do not undergo obvious signs of distress or damage, as a result of which they should be reusable.

Preferably the inlets at each end of the bolt holes are tapered.

Other preferred features are defined in the dependent claims. The invention also provides an aircraft wheel comprising a wheel hub assembly as defined above.

For a better understanding of the invention and to show how the same may be carried into effect reference will be made by way of example to the accompanying drawing, the single FIGURE of which is a sectional view of part of an aircraft wheel.

The aircraft wheel comprises two halves or hubs 1 and 2, bolted together at intervals around the wheel axes by bolts 3 passing through aligned bolt holes 8. The hubs are made of aluminium alloy or the like. Each bolt 3 has at one end a head 5, which may be of the 6 or 12 point type and at the other end a nut 4. The nut 4 includes a two or three crimp type locking mechanism (not shown). The bolt hole 8 is countersunk at 9 at its ends, the included angle of the countersunk portion being 140°. Such an assembly is called an “A” frame assembly and has a radius portion r near the tubewell t. According to the invention and as illustrated, an annular washer 10 of tapered shape has an outer surface 11 which in use is in contact with the countersunk wall 9 of the bore 8. The washer outer wall 11 tapers with an included angle of 140° (corresponding to the countersink 9 of the bore 8). The washer is made of stainless steel which is not hard and is ductile, preferably a passivated stainless steel according to BS.6580. The washer has a hole 12. The other surface, i.e. the inner of the washer 10, has a flat shoulder for receiving the head of the bolt 3 and nut 4. As shown, this is defined by a recess 13 at the wider end of the washer but it may just be a flat surface at that end. Between the two hubs is an interlocking portion comprised of a cut-out around the periphery of the wheel half 1 and a projection in the wheel half 2 which engage one with another and which define a sealing groove 15 containing an appropriately shaped O ring 14 in known manner.

The bolt holes 8 are evenly spaced about the wheel. Preferably each bolt assembly has a tapered washer 10 at each end. Our evaluations have established that a number of benefits arise from the use of tapered washers as illustrated. The clamping load is spread over a bigger area; the tapered washers are found to give better clamping, resulting in reduced separation and relative movement at both the washer/hub and hub/hub interfaces, so reducing or eliminating fretting damage. Surprisingly it has also been found that dynamic stress levels are reduced at the contact interfaces in the area of the sealing groove between the half hubs and in the hoop stresses around the bolt holes. While we do not wish the monopoly to be restricted by the following theory, our evaluations suggest that because of the tapered shape the washer acts as a spigot between the respective bolt head or nut and the hub. The reduced dynamic stresses suggest that weight savings will be possible through reductions in material thickness. The larger principal stresses are moved away from the fillet radius portion r.

Because there is no separation of the washer from the hub surface, the bolts are less subject to fatigue during dynamic loading of a wheel. In this way one avoids a bending of the bolt head or nut that can result in a fatigue failure of the bolt.

The new wheel design exhibits another improvement over the previous design in the form of a major reduction of fretting between the mating surfaces of the two clamped half hubs. This reduction in fretting is due to the spigotting action of each tie bolt, nut and conical washer assembly between both half hubs and a reduction in the amount of separation at the outer diameter of the half hubs due to improved radial distribution of bolt pre-load normal to the surface of the conical spot face.

The invention is not limited to the embodiment shown. The angle of taper will vary according to the shape of the countersunk bolt hole, the position relative to the sealing groove and the nature of the bolts and nuts. The material of which the tapered washer is made may be different. The bolts and nuts may be of shapes different from that shown. The invention is applicable to wheels on vehicles other than aircraft for example, high performance road vehicles.

1. A high performance wheel hub assembly comprising two axially adjacent hub portions of lightweight material bolted together by circumferentially distributed fastening assemblies comprising bolts extending through bolt holes in the hub portions, the bolt holes in at least one hub portion having tapered countersunk portions in which are seated complementary expanded portions of the fastening assemblies, the countersunk portions being located and dimensioned to reduce the maximum principal stress in the surrounding region of said hub portion during use.

2. A wheel hub assembly according to claim 1, wherein the expanded portions comprise washers having a generally conical profile.

3. A wheel hub assembly according to claim 2, wherein the washers are made of stainless steel.

4. A wheel hub assembly according to claim 2 or 3, wherein the washers are made of BS. 6580 stainless steel.

5. A wheel hub assembly according to any preceding claim, wherein the included angle of the countersunk portion is in the range of 85° to 150°.

6. A wheel hub assembly according to claim 5, wherein the included angle is in the range of 100° to 140°.

7. A wheel hub assembly according to any preceding claim, wherein the hub portions are made of aluminium alloy.

8. A wheel hub assembly according to any preceding claim, wherein the expanded portions are disposed adjacent a fillet in a hub portion.

9. A wheel hub assembly according to any preceding claim, wherein the expanded portions have a hardness value of at least 255 HB.

10. A wheel hub assembly according to any preceding claim, wherein the expanded portions are washers.

11. A vehicle having a wheel comprising a wheel hub assembly as claimed in any preceding claim.

12. A vehicle according to claim 11, comprising an aircraft.

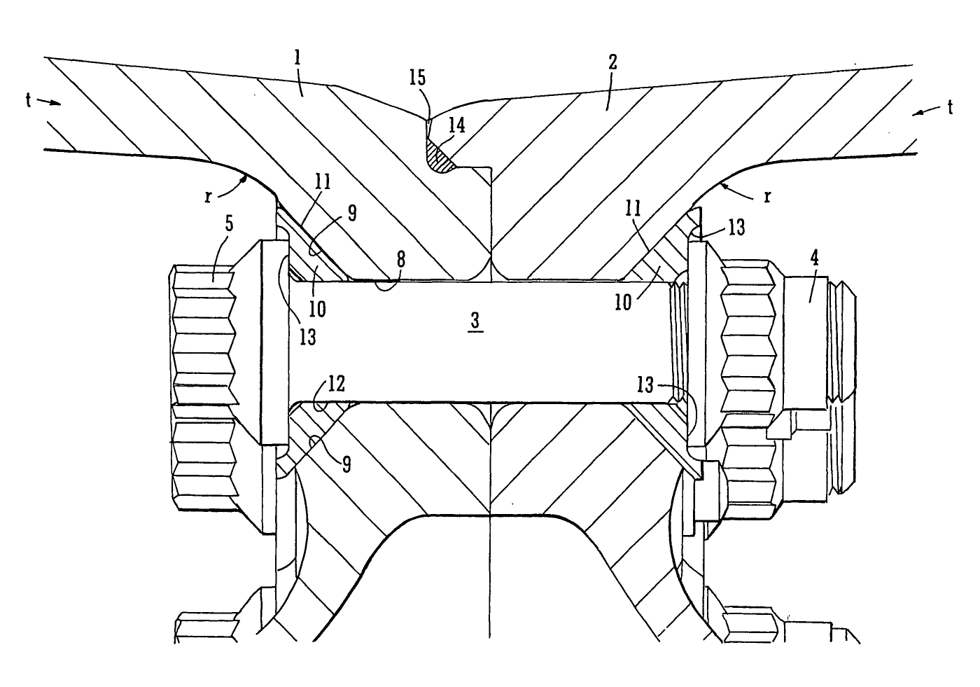

13. A wheel hub assembly substantially as described with reference to FIGURE 1 of the accompanying drawing.
